(19) United States
(12) Patent Application Publication
(10) Pub. No.: US 2001/0037279 A1
(43) Pub. Date: Nov. 1, 2001

(54) Facilitating buying and selling transactions

(76) Inventor: David Chin Lay Yeo, Singapore (SG)

Correspondence Address: MERCHANT & GOULD PC, P.O. BOX 2903, MINNEAPOLIS, MN, 55402-0903, US

(21) Appl. No.: 09/798,697

(22) Filed: Mar. 2, 2001

(30) Foreign Application Priority Data
Mar. 3, 2000 (SG) 200001128-8

(51) Int. Cl. G06F 17/60

(52) U.S. Cl. 705/37; 705/26

(57) ABSTRACT

Items can be traded by allowing sellers to specify a number of different offer prices for respective varying quantities of the, and allowing buyers to submit purchase instructions for those items. The purchase instructions are met at the lowest available price on a “first come, first served” basis. This can create an initial rush of demand in purchase of the items at a favourably low price.

### FIELD OF THE INVENTION

The invention relates to methods of market facilitation, and relates particularly but not exclusively to methods and systems for selling quantities of a tradeable item to buyers.

### BACKGROUND OF THE INVENTION

Various market facilitation systems have been devised to allow buyers and sellers to trade items. With the advent of the Internet and mass media communications there are an increasing number of possibilities for market facilitation. However, presently existing systems are not entirely satisfactory.

Auctions are one example of a type of market facilitation system. However, even when auctions are conducted with the assistance of the Internet, there are various disadvantages associated with their conduct. For example, as with conventional auctions, the system is open to manipulation by the submission of false bids which can be used to artificially drive up the bids. Further, many auctions conducted over the Internet are not suited to handling the sale of a large quantity of a particular item. Also, even with the potentially large audience provided by the Internet, it may take days or even weeks for an item to sell.

It is an object of the invention to address these and other shortcomings associated with existing market facilitation systems.

### SUMMARY OF THE INVENTION

The inventive concept resides in a recognition that an advantageous method of market facilitation can be achieved by allowing sellers to specify a number of different offer prices for respective varying quantities of a tradeable item, and allowing buyers to submit purchase instructions for those items. The purchase instructions are met at the lowest available price on a “first come, first served” basis. Offering items in a series of increasing prices may create a larger potential audience of buyers, and stimulate interest in the purchase of the items.

Accordingly, the invention provides a method of market facilitation, the method including:

providing information defining a plurality of offer prices for respective quantities of a tradeable item, said offer prices being in respect of at least two different amounts;

registering one or more purchase instructions for respective quantities of said tradeable item; and

accepting one or more of said one or more purchase instructions at one or more of said offer prices, said one or more purchase instructions being accepted for progressively increasing offer prices.

Preferably, the method includes the option to withdraw the purchase instructions for a predetermined interval after registration of the purchase instructions. If an item is rejected during this “cooling off” period, then the list is updated to include this previously purchased item. Preferably, the cooling period ends when the last item is sold.

Preferably, the prices of all the remaining items are adjusted to take account of the inclusion of the rejected item, which was necessarily purchased at an offer price lower than the offer prices of any of the items subsequently on offer.

Preferably, the offer prices of all remaining items (that is, including the rejected item) are all adjusted so that the sum total of all the individual offer prices is the same as the sum total of the individual offer prices of the previously listed items (that is, excluding the rejected item). Accordingly, the offer prices are decreased a certain amount as the rejected item was necessarily sold at an offer price lower than any of the remaining offer prices.

Preferably, when any item is purchased, the offer prices of all remaining items are updated when necessary to take into account any rejected items.

The invention also provides a system for market facilitation able to perform the inventive methods described above.

Throughout this specification, reference to an item or tradeable item includes reference to tangible items as well as intangible items such as financial or legal instruments. Reference to a tradeable item further includes combinations of tradeable items. Also, reference to prices, and in particular offer prices, includes reference to amounts specified in terms of an official legal tender, as well as amounts specified in terms of other directly comparable values. The invention encompasses methods and systems involving all such variations.

### DESCRIPTION OF DRAWINGS

FIGS. 1 and 2 depict a flowchart illustrating the procedure for conducting a sales session according to an embodiment of the invention.

### DESCRIPTION OF EMBODIMENTS

Market facilitation is achieved with an embodiment of the invention within the framework of a sales session in which sellers sell to one or more buyers. A sales session is announced before its commencement to prospective buyers. This announcement includes an indication of the type and quantity of the items to be sold, as well as the time, date and duration of the sales session. Other details are also announced, as outlined below. This period after announcement of the sales session and before the start of the sales session is called the notification period.

Buyers can view the seller's offer prices during the notification period. A seller offers an item within a particular price range. Typically, each item is offered at a different offer price, and each successive offer price is incrementally greater than the next lowest offer price by a certain fixed amount, such as $1. For example, 100 items may each be offered at prices between $1 and $100, such as $1, $2, $3 and do on up to $100.

Once a seller settles on a quantity of items to be offered, and the price range of offer prices for the items, a list of offer prices is produced for respective quantities of the item. As mentioned, it is usual that the respective quantity is one, so that each particular item has its own unique offer price, incrementally greater than the next lowest price by a fixed incremental price step. This list of offer prices is ordered in ascending order of the offer prices. The list of offer prices is displayed for perusal by prospective buyers.

It is, of course, not necessary to display a list. In certain cases it is desirable not to display a list as the number of entries would be excessive. Instead, it is only generally required to provide information which indicates the range of offer prices that are available. For example, it can be stated that 1000 items are offered at prices from $501 to $1500 at an offer price increment of $1. This provides all necessary information, and avoids listing, in a table, the offer prices as $501, $501, $502 . . . $1500.

Buyers express interest in purchasing quantities of an item, but are typically limited to one purchase per purchase instruction. These purchase instructions are accepted, in the order in which they are registered on a ‘first come first served” basis. The purchase instructions are effectively queued in a queue which provides that purchase instructions are accepted in the order in which they are registered. The purchase instructions are sequentially accepted at successively increasing offer prices according to the ascending list of said offer prices. Early buyers purchase at lower prices, while later buyers can only purchase items having a higher offer price.

Prior to conducting a sales session, there are certain obligations on both buyers and sellers. These are outlined below.

Sellers

Before commencing a sales session, a seller gives notice of the following details in relation to a particular item it wishes to sell:

1 Total Quantity of the Item

The seller discloses the quantity of each item that it wishes to sell. This provides buyers with an indication of the likelihood of successfully buying an item during a sales session.

2 Price Range for the Item

This is the range of the lowest price per item to the highest price per item.

3 Purchase Contract Between Sellers and Buyers

The purchase contract is the sales contract between buyers and sellers, and includes appropriate clauses concerning warranty, return policies, etc.

4 Payment Method

This may be, for example, by credit card, bank cheque or personal cheque.

5 Delivery Mode

This provides options as to delivery of the item, for example, by courier, air mail etc.

6 Delivery Schedule

This allows an indication of when a buyer can expect to receive purchased goods.

7 Delivery Costs

An indication of delivery costs allows the buyer to assess the total cost of purchase.

8 Sales Session Details

These details include the time and date of the sales session, and any other details that may be appropriate, such as venue. Any late changes to these details are provided to buyers.

Buyers

Prior to commencement of the sales session, buyers are required to do the following:

1 Register Intention to Participate in the Sales Session

Registration involves submitting details with a session administrator (whether real or virtual). An identification code is subsequently issued linking the submitted details with the code. The identification code is used during the sales session to facilitate processing and billing at the end of the sales session.

2 Present at the Sales “Site” Before the Sales Session Starts

Buyers are required to be present at the sales “site” (whether real or virtual) before the sales session starts.

3 Agree to Sales Session Procedure and Policy

An agreement is provided for users to agree with before the start of the sales session.

4 Promise to Pay for Purchases

Part of the agreement involves buyers accepting their contractual obligations to pay for purchases made during the sales session.

5 Indicate Method of Payment

Buyers indicate their preferred payment method when registering to participate in the sales session. Buyers agree to allowing the session administrator to verify the capacity of a buyer to pay for purchases before the start of a sales session (for example, by checking credit limits).

6 Abide by Disqualification Policy

Buyers agree to be disqualified from a present or future sales session if disqualified by the session administrator

Sales Session

Once sellers have performed all the actions required of them, as listed above, the notification period starts in which details of an upcoming sales session are made known. Buyers register for the sales session during the notification period.

By default, the system uses the item quantity and the item price range to divide the quantity of items to be sold into single quantities having an offer price between the lowest and highest prices. For example, for 100 items in a range of $101 to $200 dollars, a each item is priced at prices of $101, $102, $103 etc up to $200.

Of course, non-uniform price increments can also be used. The seller may wish to specify a generally random sequence of positive increments, or provide a regular series of increasing or decreasing increments, such as 2, 4, 6, 8, 10 or 1024, 512, 256, 128, 64, 32, 16, 8, 4, 2. Decreasing increments can be used to limit the number of items that are offered at particularly low offer prices, increasing competition between buyers and limiting the exposure of sellers. Once price increments reach a certain lower level, then can be held constant for all remaining items.

The following events, as outlined below, occur during a typical sales session.

1 Notification of Sales Session

The sales session and offer prices all offered to all buyers simultaneously.

2 The Lowest Priced Item is the First Item Offered for Sale

The system sells the lowest priced item first, and the highest priced item last.

3 Buyers can Only Accept or not Accept Offers

The system allows buyers to accept or not accept particular offers. In some cases, as explained below, buyers are given the opportunity to withdraw their acceptance of an offer within a specified time period.

4 “First Come, First Serve”

After the sales session starts, all buyers are equally able to register purchase instructions using the appropriate mechanism. The first buyer who “grabs” the offer has the chance to buy the item. A “first come first serve” policy favours buyers who are the first to register purchase instructions, allowing early buyers to purchase at a lower price than later buyers.

5 Increase in Prices

As each item is sold, the offer price increases by one incremental price step as earlier outlined.

6 Discarded Items

If a buyer discards an item after accepting an offer, the discarded item is added back to the inventory list to be sold again. When this occurs, the offer prices of all items remaining to be sold is updated to take into account the newly available item which was previously considered sold.

Discarded items are lower in price that the items currently on sale. Accordingly, it is appropriate to adjust the cost of both the discarded item and the remaining items on offer to take account of the new item now available. Most preferably, this involves increasing the offer price of the rejected or discarded item, but decreasing the offer price(s) of the remaining items.

An illustrative example of this price redetermination described above is now provided. Consider 100 items, in which the first item has an offer price of $1 and the last item has an offer price of $100. After item 99 is purchased, a buyer discards item 1 which was purchased for $1. Accordingly, there are now two items in the list: item 100 and the discarded item, item 1.

These two items have a combined cost of $101, $1 for item 1 and $100 for item 100. However, the offer prices of both items is redetermined so that the first item (item 1) is offered at an offer price of $50, and the second item (item 100) is offered at an offer price of $51.

Price redetermination provides a means which makes the offer prices of the remaining item(s) more attractive to buyers as the offer prices are always lowered when a discarded item is added to the inventory list. The sum total of the offer prices received by a seller is maintained, so that the seller is not penalised by buyers who discard items. Also, if a buyer later accepts an offer price for an item that was earlier discarded, that offer price will invariably be higher than the initially accepted offer price.

The expression for calculating the lowest redetermined offer price is:

$$Price of last offer - ( \frac{Price of last offer - Price of discarded item}{Number of items in stock + One reject} )$$

$$The expression \text{:}$$

$$( \frac{Price of last offer - Price of discarded item}{Number of items in stock + One reject} )$$

represents the amount by which the remaining unsold items are all reduced in price, while the whole expression above (that is, the difference with the amount of the last sold item) represents

In this case, the figures are:

$$Price of current offer = 99 - ( \frac{99 - 1}{1 + 1} )$$

Accordingly, the first item is offered at $50, and the next item is offered at a price which is one incremental price step above that price, namely $51.

A more realistic example further example is now provided.

| | |
|---|---|
| Quantity of items: | 100 |
| Price spread: | $1 to $100 |
| Incremental price: | $1 |

Consider that the item currently on offer is item 91, the last sold item being item 90, sold for $90), and that item 2, bought at $2 is discarded.

By using the expression above,

$$90 - ( \frac{90 - 2}{10 + 1} ) = \$82$$

Accordingly, discarded item 2, originally sold for $2 is now effectively re-offered at an offer price of $82. This is the lowest of all of the remaining offer prices either before or after they have been redetermined. These remaining items are offered at offer prices which are incrementally greater than the reoffered item 2 by one price step (in this case, $1). Equivalently, the offer prices of the remaining unsold items (besides the discarded item) are each decreased by the correction amount of $8 to arrive at the redetermined offer prices.

The results of these redetermined offer prices are set out in the table below.

| | New List | | Old List |
|---|---|---|---|
| Item 2 | $90-$8 = $82.00 | instead of | — |
| Item 91 | $91-$8 = $83.00 | instead of | $91.00 |
| Item 92 | $92-$8 = $84.00 | instead of | $92.00 |
| Item 93 | $93-$8 = $85.00 | instead of | $93.00 |
| Item 94 | $94-$8 = $86.00 | instead of | $94.00 |
| Item 95 | $95-$8 = $87.00 | instead of | $95.00 |
| Item 96 | $96-$8 = $88.00 | instead of | $96.00 |
| Item 97 | $97-$8 = $89.00 | instead of | $97.00 |
| Item 98 | $98-$8 = $90.00 | instead of | $98.00 |
| Item 99 | $99-$8 = $91.00 | instead of | $99.00 |
| Item 100 | $100-$8 = $92.00 | instead of | $100.00 |

The list is updated so that the new list replaces the old list. The offer prices are redetermined as often as necessary before the inventory is sold out.

The price redetermined is performed in the same way if the offer prices are separated by non-uniform price increments. For example, consider the case in which the last sold item was sold at an offer price of $89.80. The rejected item was sold at $1.80.

If the next item was previously being sold at an offer price of $90.30, then the rejected item would instead be offered at the lower offer price of:

$$89.80 - ( \frac{89.80 - 1.80}{10 + 1} ) = \$81 .80$$

Each of the remaining offer prices would be redetermined by a reduction of:

$$( \frac{89.80 - 1.80}{10 + 1} ) = \$8 .00$$

This would occur irrespective of the actual amounts of the offer prices of the remaining unsold items, or the amount of the price increments between the successive offer prices.

Accordingly, after price redetermination, the order and the amount of the non-uniform price increments remains the same between successive offer prices, but the total amounts are adjusted to reflect the inclusion of the rejected item which has been increased in price. The increased offer price of the rejected item effectively subsidises the decreased offer prices of the remaining items.

Non-queued Variation

One variation in the operation of the system described above does not store each of the purchases instructions received from buyers in a queue, but instead requires that buyers compete against each other until they have had a purchase instruction accepted by the system administrator. This means that there are as many purchasing rounds as there are items to be sold, each purchasing round starting afresh with buyers having, at the start of each round, an equal chance of purchasing at a given offer price.

The first registered purchase instruction is accepted for a given offer. However, other variations on this theme are possible. For example, the third purchase instruction that is registered might be accepted in respect of the current offer price. As an additional feature, the first and second registered purchase instructions may be given an option of first refusal in relation to acceptance of the next offer prices. Various modifications are possible.

The non-queued variation can be implemented in various embodiments but is, in particular, described below in relation to an auction room and switch implementation.

Lottery Variation

A further variation to the operation of the system described above replaces the facility of all buyers to register purchase instructions after the start of the sales session. Instead, the option to register purchase instructions is drawn by lots—so the sales session effectively becomes a lottery. Each buyer who is awarded the option to register purchase instructions has a right of first refusal to purchasing the item at the currently available offer price. As in the usual operation of the system, the offer price increments once an earlier buyer's purchase instructions are accepted. Discarded items, and the consequent price redetermination, are handled in the same way as in the usual operation. A lottery style variation is desirable, when the offer prices are essentially nominal, and the items are essentially being given away, perhaps as part of a promotional event or other marketing initiative.

Implementation

There are various ways by which the described system can be implemented. The Internet is preferably used in many cases, though in other instances one or more other techniques may be more appropriate. A number of examples are outlined below.

1 Internet

An identity code is given to each buyer who logs onto a Web site. The Internet is an attractive mechanism for implementing the system as it allows sellers to easily reach a potentially large number of buyers. Also, offers can be made almost simultaneously to many buyers within a particular group, which is a desirable characteristic of the system.

2 Private Network

A system implemented on a private computer network, would operate almost identically to one implemented on the Internet.

3 Phone and Radio/television

In this case, the public telephone network is used in conjunction with a mass media system such as radio or television. Of course, any other suitable mass media can also be used. Sellers announce a sales session though the mass media, and buyers will call through using the telephone system to accept offers. To avoid false starts and queue jumping, the session administrator can only take calls in sequential order on one line. Calls are desirably queued to provide equal access to all buyers.

4 Fax and Radio/television

Alternatively, a facsimile machine can be used rather than a telephone. Accordingly buyers accept offer prices by facsimile rather than by telephone. Any mass media means of communicating a sales session to buyers can be used, with buyers accepting offer prices through any convenient means—fax and phone as already noted, but also through the Internet, private networks, or in person using for example, loud hailers.

5 Switch and Public Announcement (PA) Aystem

In this case, a switch can be pressed to activate a light present in a central place. There would be various switches located near respective buyers, all of which activate lights which can be monitored by the session administrator. Sales sessions would be announced by the session administrator over a public announcement or PA system, and buyers would respond by pressing their switch. Such an implementation is most suitable within a building where buyers have allocated spaces, and the PA system covers all buyers. Instead of using a PA system, a suitable mass media could alternatively be used. Similarly, instead of using a light-activating switch, a private phone exchange could be used by buyers to alternatively call or fax in their purchases, as in other implementations.

6 Auction Room and Switch

Buyers gather in a room with the session administrator controlling the purchase process. Each buyer has a switch, which is pressed to make a purchase by lighting up a light associated exclusively with a particular buyer. The lighting system is wired to only light up one particular light at any given time (and thus accept only one purchase instruction at once). In this case, each buyer competes for each offer price by attempting to be the first buyer to press the light and thus secure the purchase. When the item has been purchased, the buyers again compete against each other to buy the next item. Thus there are as many purchasing rounds as there are items to be sold.

Alternatively, a display panel can be used to indicate the order in which each buyer accepts an offer price by pressing their switch. In this case, a queue of registered purchase instructions is formed, and with successively registered purchase instructions being accepted at progressively higher offer prices.

Disqualification

As mentioned earlier, buyers abide by the session administrator's ruling of disqualification. There are various grounds by which a buyer may be disqualified. These are outlined below.

1 Failure to Register

Buyers must register with the session administrator to participate in a sales session. Registered buyers must provide all details requested by the session administrator. If a buyer fails to register, or does not register correctly or provide the session administrator with all necessary details, the buyer will be ineligible to participate in the sale session, or can be disqualified from the sales session.

2 Premature Purchases

Any buyers who attempt to “false start” or “jump the gun” by accepting a sales offer before the session administrator opens the sales session may be disqualified from the sales session, as this can deprive other buyers of making an early purchase at a low offer price.

3 Preventing Others from Purchasing

Buyers who attempt to prevent or delay other buyers from purchasing, possibly obtaining an advantage for themselves, can be disqualified.

### EXAMPLE

An illustrative example is now given, in relation to the accompanying flowchart, of the events which typically occur during a sales session.

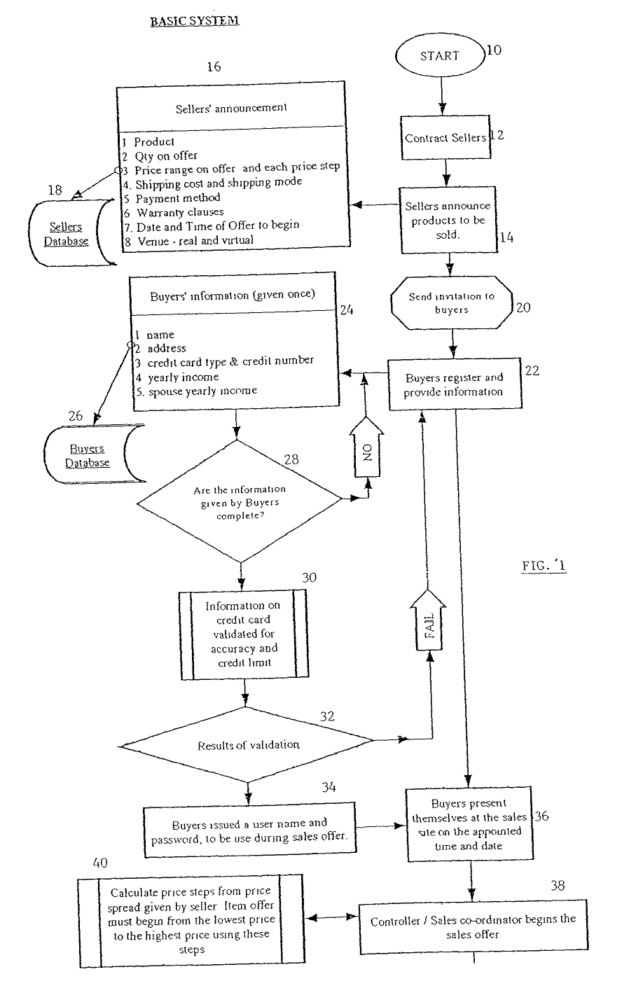

With reference to FIG. 1, initially 10 sellers are contracted 12 to participate in a sales session. Once contracted, sellers announce 14 items to be sold during the sales session. This announcement 16 involves details of:

1. product

2. quantity on offer

3. price range on offer, and each price increment

4. delivery costs and delivery mode

5. payment methods

6. warranty clauses

7. date and time of the start of the sales session

8. venue—real or virtual

These details are stored in a sellers database 18 and can be accessed as required.

Once a session is announced 14, invitations are sent 20 to prospective buyers. In response, buyers register 22 and provide all relevant information. New buyers who have not previously registered with the system need to supply details 24 such as:

1 name

2 address

3 credit card details

4 yearly income

5 spouse yearly income

This information is stored in a buyers database 26, and accessed when the same buyer registers for a subsequent sales session. If the details provided by the buyer are incomplete 28, then the buyer is required to complete the required information 24. Credit card details are then validated 30 for accuracy and credit limit. If the results of this validation are satisfactory 32, then the buyer is issued 34 with a user name and password to be used during the sales session and in subsequent sales session. If the results are not satisfactory, the buyer is not registered, but is invited to reregister 22.

Once registered, buyers present 36 at the sale site at the appointed time and date. The session administrator starts 38 the sales session. The prices of each quantity of item are calculated 40 as described above, based on the range of offer prices chosen by the seller. Typically, as mentioned above, each single item is allocated a different offer price, ranging from the lowest price to the highest price.

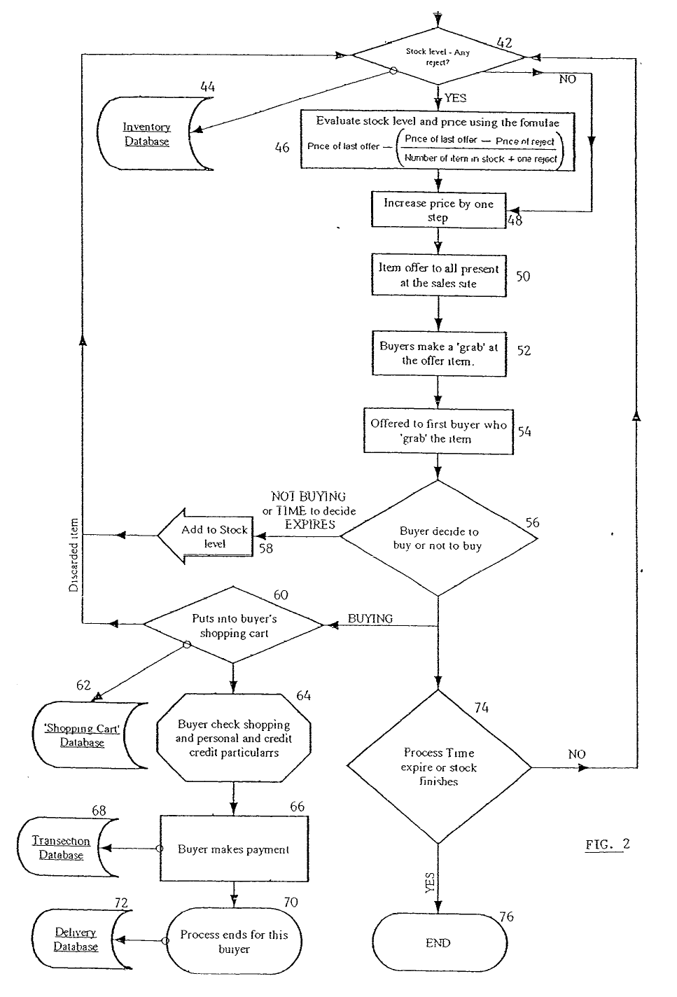

Turning to FIG. 2, the system continuously monitors whether any items are discarded 42 by a buyer rejecting the item. The occurrence of rejected items is reflected in the inventory database 44. When this occurs, the price of the remaining items is redetermined 46 as described above. After a purchase 56, the price of remaining stock is incremented 48 by one step, whether or not the item offer price is redetermined 46. The items are offered 50 to all buyers, and buyers are of course free to accept 52 offer prices for those items. The lowest priced items are offered 54 to those buyers who accept purchase of the items first.

Once an item is purchased 56, it is checked whether any previously purchased items have been rejected 42. The offer prices of the remaining items are redetermined 46 if necessary, depending on the presence or absence of rejected items as described above. The purchased item is added 60 to the buyer's shopping cart, and the relevant details updated in the shopping cart database 62.

The buyer's personal and credit details are checked 64 and the buyer makes payment 66 for the item. The transaction database 68 is updated accordingly. Once this is completed, the process ends 70 for the buyer. The relevant details are used to update the delivery database 72, and the item is dispatched for delivery.

The sales session continues with buyers purchasing 56 items, and prices incrementing 48 until either the session is completed or all items are purchased 74. Once either of these events occur, no more purchases are accepted and the session is completed 76.

Advantages

The system has a number of particular advantages for sellers and buyers wishing to sell or but items using the system.

1 High Volume Disposal

There are various advantages associated with the above described methods. The method is particularly well suited to quickly disposing of a large quantity of stock, as the price can be set to start relatively low and increase in small increments. Clearing large quantities of stock is obviously desirable, for example, when clearing outdated product models, launching a new product, or clearing stock before conducting a stocktake or inventory audit.

When there is only one price level, there are only so many buyers willing to pay that price. However, when there are a number of price levels, there is accordingly a far greater buyer audience attracted to at least one of those price levels.

2 Captive Audience

When supply is high and demand is low, buyers tend to take their time in deciding whether to purchase. In this system, however, a quick response is rewarded and accordingly, buyers are prompted into action by the possibility of purchasing at a lower price. Further, buyers enter a sales session with the intention of purchasing at their preferred price level.

3 Initial Rush

When the offer price is at its lowest, frantic purchase decisions are initially made. This competitive purchasing generates an urgency to the buyers' purchasing behaviour. As long as there is perceived to be particular value at the offer price, there will be buyers accepting offer prices.

4 Transparency

Product and sales information can be published during the notification period, within which buyers can decide whether they wish to participate. Buyers have access to information concerning price spread, policies, contracts, prices, quantity, time and date etc. This is typically attractive to prospective buyers.

5 Difficult to Manipulate

The mechanism of redetermining prices once an accepted offer price is withdrawn in relation to a discarded item avoids the possibility of prices being artificially inflated through false purchases.

6 Avoid “Middlemen”

The system allows items to be distributed directly to individuals without the need to engage third parties such as retail outlets. This can provide a cost saving which can be passed onto the end purchasers.

The system is flexible as it allows large lots of an item to be divided into a number of smaller lots, and for large numbers of registered buyers to be grouped into smaller groups for sales sessions which are more easily managed. Multiple sales sessions can be held at the same time and date at different sales sites.

The system is suitable for both B2C (business to customer) transactions as well as B2B (business to business) transactions. In a B2B model, commercial items and commercial quantities are most suitably offered for sale, although consumer items can also be sold.

1. A method of market facilitation, the method including:
providing information defining a plurality of offer prices for respective quantities of a tradeable item, said offer prices being in respect of at least two different amounts;
registering one or more purchase instructions for respective quantities of said tradeable item; and
accepting one or more of said one or more purchase instructions at one or more of said offer prices, said one or more purchase instructions being accepted for progressively increasing offer prices.

2. A method as claimed in claim 1, wherein said one or more purchase instructions are accepted in the order in which they are registered.

3. A method as claimed in claim 1, wherein, in respect of one or more of said offer prices, one or more purchase instructions are registered for respective quantities of said tradeable item, and the first registered purchase instruction of said one or more registered purchase instructions is accepted in respect of that offer price.

4. A method as claimed in claim 1, wherein a sequence order of said one or more registered purchase instructions is established and an option of first refusal of acceptance of a respective one of said one or more registered purchase instructions is provided, in said sequence order, in respect of said offer prices.

5. A method as claimed in claim 4, wherein said sequence order is random.

6. A method as claimed in any one of claims 1 to 5, wherein said one or more purchase instructions are only accepted during a predetermined time interval.

7. A method as claimed in any one of claims 1 to 6, wherein said offer prices vary between a lowest offer price and a highest offer price in equal incremental price steps.

8. A method as claimed in any one of claims 1 to 6, wherein said offer prices vary between a lowest offer price and a highest offer price in non-uniform incremental price steps.

9. A method as claimed in any one of claims 1 to 8, wherein said respective quantities of said tradeable item are each one.

10. A method as claimed in any one of claims 1 to 9, wherein an accepted purchase instruction can be withdrawn within a predetermined time interval after registration of said purchase instruction.

11. A method as claimed in claim 10, wherein said predetermined time interval ends when a purchase instruction for the highest of said offer prices is accepted.

12. A method as claimed in claim 10 or 11, wherein, following withdrawal of a purchase instruction to include the rejected quantity of said tradeable item, one or more of said one or more registered purchase instructions can be accepted in respect of said rejected item.

13. A method as claimed in claim 12, wherein the offer price for which said one or more purchase instructions in respect is accepted for said rejected item is greater than the offer price originally accepted in respect of that item.

14. A method as claimed in any one or claims 10 to 13, wherein said offer prices of all items are adjusted if one or more registered purchase instructions are accepted in respect of said rejected item, such that the sum total of the offer prices of all respective quantities of all items remains constant.

15. A method as claimed in any one of claims 10 to 14, wherein said rejected item is the first item to be sold at a price calculated according to the expression:
$$X - ( \frac{X - Y}{N + 1} )$$
where:
X=Offer price of item for which a purchase instruction was most recently accepted
Y=Offer price of the rejected item
N=Number of items for which purchase have not been accepted

16. A method as claimed in claim 15, wherein each of said offer prices of said remaining items is decremented by the amount calculated according to the expression:
$$( \frac{X - Y}{N + 1} )$$
where:
X=Offer price of item for which a purchase instruction was most recently accepted
Y=Offer price of the rejected item
N=Number of items for which purchase have not been accepted

17. A method as claimed in any one of claims 1 to 16, wherein said provision of information is achieved by providing a list of offer prices for respective quantities of a tradeable item.

18. A method as claimed in claim 17, wherein said list is ordered in ascending order of said offer prices.

19. A method as claimed in claim 17 or 18, where said list is updated after each acceptance of a purchase instruction, and each withdrawal of a purchase instruction to reflect the offer prices for which registered purchase instructions can be accepted.

20. A method as claimed in any one or claims 1 to 19, wherein said one or more purchase instructions are provided for registration by a plurality of buyers to a central entity which administers the registration and acceptance of purchase instructions in respect of a tradeable item.

21. A method as claimed in claim 20, wherein said buyers are substantially simultaneously advised of said offer prices.

22. A method as claimed in any one of claims 1 to 21, wherein said tradeable item can include a predetermined combination of items.

23. A system for market facilitation, the system including:
means for providing information defining a plurality of offer prices for respective quantities of a tradeable item, said offer prices being in respect of at least two different amounts;
means for registering one or more purchase instructions for respective quantities of said tradeable item; and
means for accepting one or more of said one or more purchase instructions at one or more of said offer prices, said one or more purchase instructions being accepted for progressively increasing offer prices.
